(19) United States
(12) Patent Application Publication
(10) Pub. No.: US 2015/0125236 A1
(43) Pub. Date: May 7, 2015

(54) THRUST SCREW FOR BEARING AGAINST AN AXLE

(71) Applicant: Tsai-Chi Lin, Taichung City (TW)

(72) Inventor: Tsai-Chi Lin, Taichung City (TW)

(21) Appl. No.: 14/074,671

(22) Filed: Nov. 7, 2013

(51) Int. Cl. F16B 35/00; F16C 19/10

(52) U.S. Cl. CPC F16B 35/00; F16C 19/10
USPC 411/393

(57) ABSTRACT

A thrust screw for bearing against an axle includes a screw body, a first race member and a row of rolling elements. The screw body has a head and a shank. The head has opposing first and second surfaces, and the shank integrally extends from the first surface of the head. The first race member is disposed around the shank of the screw body. In particular, the head of the screw body serves as a second race member and cooperates with the first race member to co-define an annular track therebetween. And the row of rolling elements is disposed in the track between the first race member and the head of the screw body.

### BACKGROUND OF THE INVENTION

1. Field of the Invention The present invention relates to a screw and more particularly to a thrust screw for axially bearing against an axle.

2. Description of the Related Art

A thrust bearing is a particular type of rotary bearing. Like other bearings they permit rotation between parts, but they are designed to support a predominately axial load. As shown in FIG. 4, a conventional thrust bearing 91 is retained by a screw 92 to support an axial load generated by an axle 94. Specifically, the thrust bearing 91 is disposed in a housing 93 and the screw 92 is screwed into an end of the axle 94. The thrust bearing 91 includes a pair of race members 95, 96 and a row of balls 97 sandwiched in between the race members 95, 96. One of the race members 95 abuts against the housing 93 while the other race member 96 abuts against a head of the screw 92. To avoid abrasion, a bushing 99 may be employed in a central bore 99 of the thrust bearing 91 to separate the thrust bearing 91 from the screw 92.

As described above, an apparatus is generally made up of a number of mechanical parts. The quality of the apparatus consists of several components like precision and accuracy in respective mechanical parts. Thus, if the number of mechanical parts is increased, the apparatus gains not only more weight but also an increase in accumulated tolerance and therefore causes a loss in the quality. Whilst the conventional apparatus as shown in FIG. 4 is satisfactory for most duties, there is always a desire to provide an apparatus with less weight and smaller accumulated tolerance.

### SUMMARY OF THE INVENTION

Accordingly, it is an object of the present invention to provide a thrust screw for bearing against an axle, which contributes less weight and smaller accumulated tolerance.

Specifically, the thrust screw includes a screw body, a first race member and a row of rolling elements. The screw body has a head and a shank. The head of the screw body has opposing first and second surfaces. The shank of the screw body integrally extends from the first surface of the head. The first race member is disposed around the shank of the screw body. In particular, the head of the screw body serves as a second race member and cooperates with the first race member to co-define an annular track therebetween. The rolling elements are disposed in the track between the first race member and the head of the screw body.

As described above, the thrust screw is merged from a conventional thrust bearing and a conventional screw in a manner that the weight of the thrust screw is less than a total weight of the thrust bearing and the screw, and the accumulated tolerance of the thrust screw is smaller than that of the thrust bearing and the screw.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a thrust screw in accordance with the preferred embodiment of the present invention;

FIG. 2 is an exploded perspective view of the thrust screw shown in FIG. 1;

FIG. 3 is a cross-sectional view of the thrust screw shown in FIG. 1, taken along line and

FIG. 4 is a prior art.

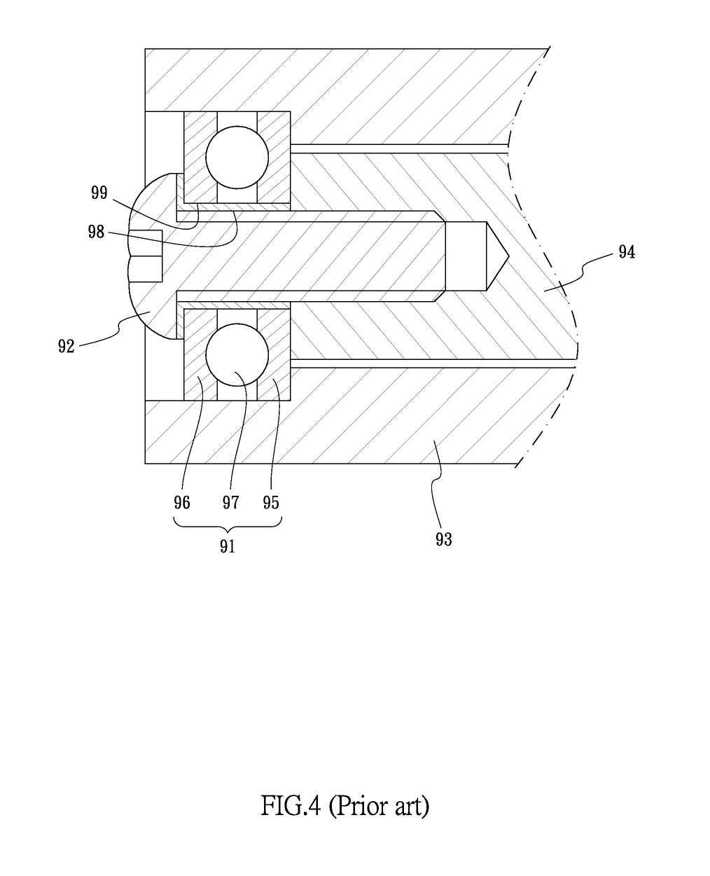

### DETAILED DESCRIPTION OF EMBODIMENTS

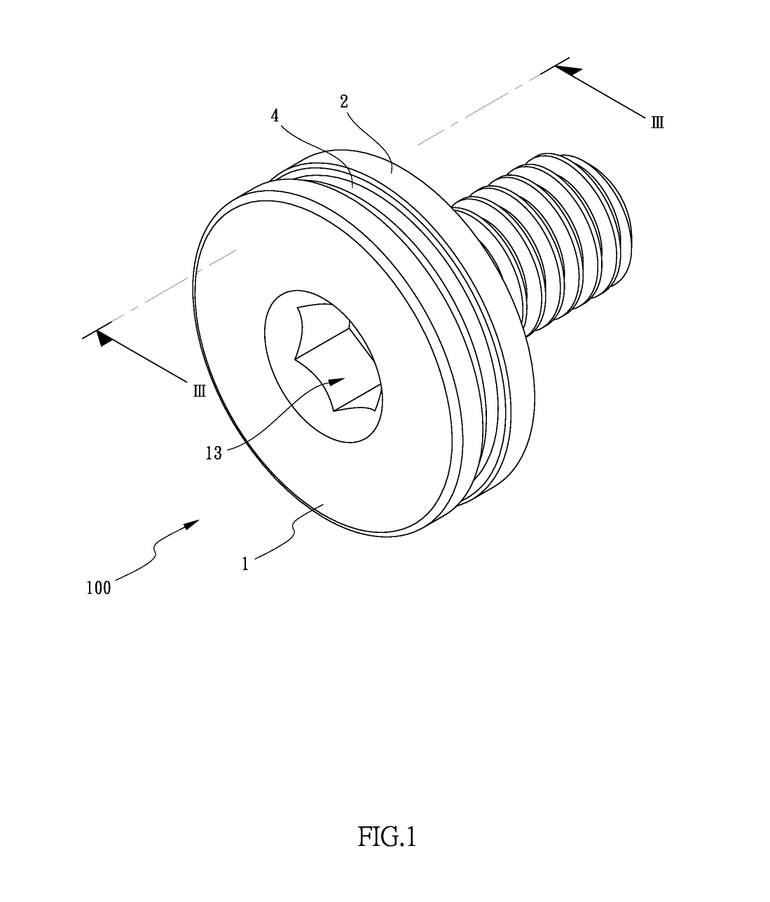

Referring to FIGS. 1-3, there is shown a thrust screw 100 for bearing against an axle. As shown, the thrust screw 100 includes a screw body 1, a first race member 2, a row of rolling elements 3 and a retainer 4.

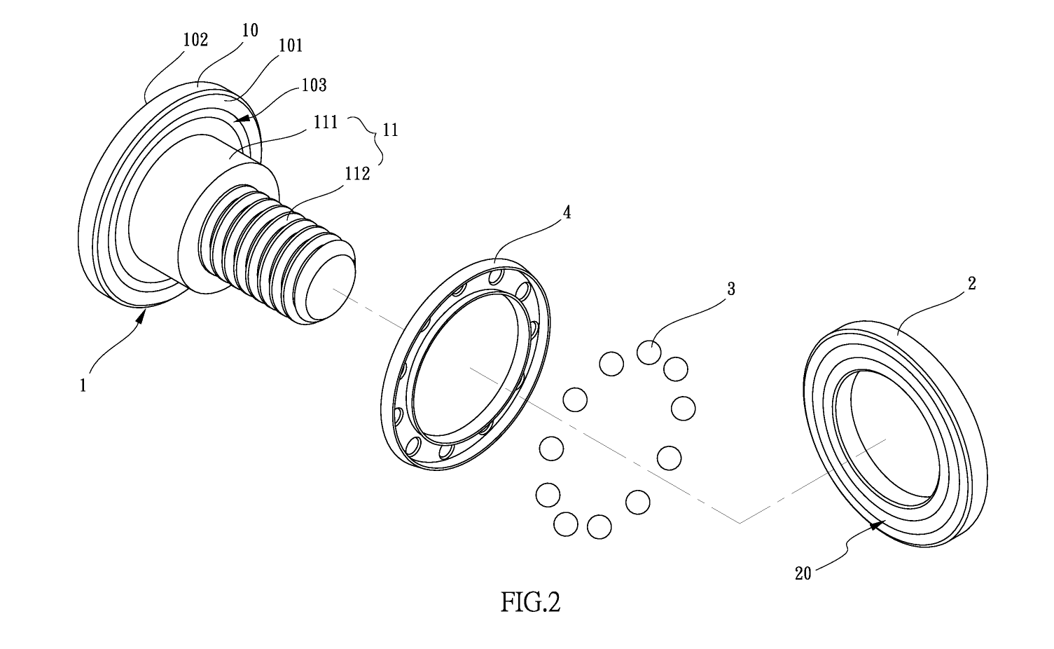

As shown in FIG. 2, the screw body 1 of the thrust screw 100 has a head 10 and a shank 11. The head 10 of the screw body 1 has opposing first and second surfaces 101. 102. The shank 11 of the screw body 1 extends integrally from the first surface 101 of the head 10, and includes a large-diameter smooth section 111 and a small-diameter threaded section 112. The large-diameter smooth section 111 of the shank 11 extends from the head 10 and around which the first race member 2 is disposed. The small-diameter threaded section 112 extends from the large-diameter smooth section 111 to be screwed into the axle.

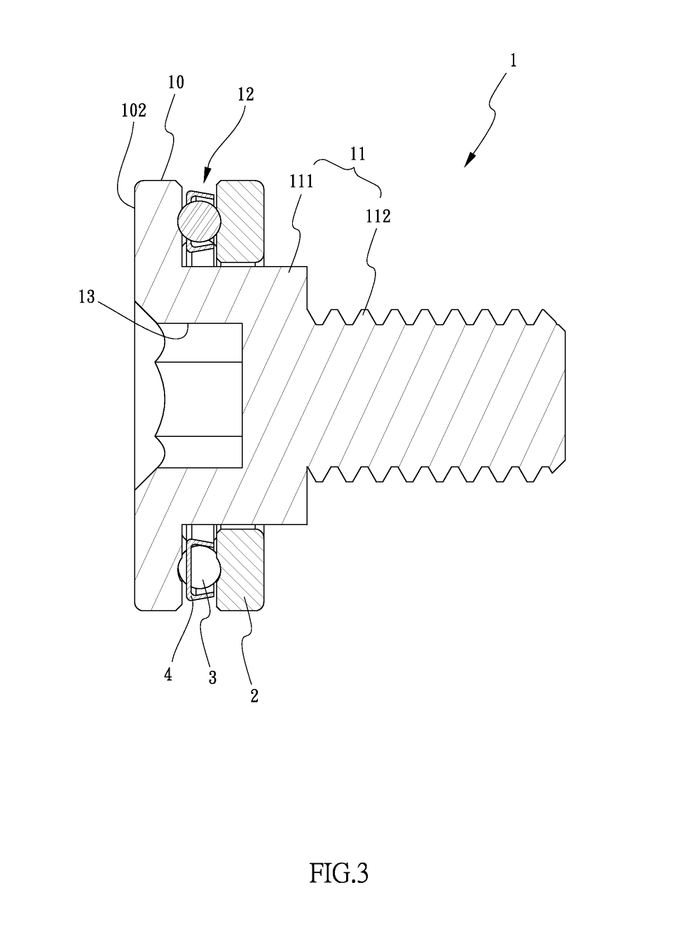

As shown in FIG. 3, the first race member 2 is disposed around the large-diameter smooth, section 111 of the shank 11 of the screw body 1. And the head 10 of the screw body 1 serves as a second race member and cooperates with the first race member 2 to co-define an annular track 12 therebetween. The row of rolling elements 3 is rollably disposed in the track 12 between the first race member 2 and the second race member, namely the head 10 of the screw body 1. In this example, the rolling elements 3 are spherical rotors; however, in other examples, the rolling elements 3 may be cylindrical rollers.

More specifically, as shown in FIG. 2, the head 10 of the screw body 1 defines an annular groove 103 in a periphery of the first surface 101 thereof. On the other hand, the first race member 2 defines an annular groove 20 axially opposing to that of the head 10 of the screw body 1 such that the annular track 12 is formed between the head 10 of the screw body 1 and the first race member 2. In addition, as shown in FIG. 3, the retainer or cage 4 is mounted around the large-diameter smooth section 111 of the shank 11 of the screw body 1 and is sandwiched in between the head 10 of the screw body 1 and the first race member 2 so as to hold the rolling elements 3 from interacting one another.

As shown in FIG. 1 or 3, the head 10 of the screw body 1 has at its second surface 102 an engaging portion 13 for engaging with a screw-tightening tool (not shown). In this example, the engaging portion 13 of the head 10 of the screw body 1 is a hexagonal recess extending through the head 10 to the large-diameter smooth section 111 of the shank 11 of the screw body 1, as best seen in FIG. 3. However, in other examples, the engaging portion 13 of the head 10 of the screw body 1 may be a cross slot for engaging with a Phillips screwdriver, a straight slot for engaging with a flat-head screwdriver or an outside hexagon for engaging with a wrench.

As described above, the thrust screw 100 of the present invention is merged from a conventional thrust bearing and a conventional screw and has characteristics of the two, but contributes less weight and smaller accumulated tolerance.

It is to be understood that the disclosed embodiments are illustrative in nature and the invention is not to be limited to any one or more embodiments except as set forth in the following claims.

What is claimed is:

1. A thrust screw for bearing against an axle, comprising:
a screw body having a head and a shank, the head having opposing first and second surfaces, and the shank integrally extending from the first surface of the head;
a first race member disposed around the shank of the screw body; wherein the head of the screw body serves as a second race member and cooperates with the first race member to co-define an annular track therebetween; and
a row of rolling elements disposed in the annular track between the first race member and the head of the screw body.

2. The thrust screw of claim 1, wherein the rolling elements are spherical rotors.

3. The thrust screw of claim 2, wherein the head of the screw body defines an annular groove in a periphery of the first surface thereof, and the first race member defines an annular groove axially opposing to that of the head of the screw body such that the annular track is defined between the head of the screw body and the first race member.

4. The thrust screw of claim 1, further comprising a retainer that is mounted around the shank of the screw body and sandwiched in between the head of the screw body and the first race member so as to hold the rolling elements from interacting one another.

5. The thrust screw of claim 1, wherein the shank of the screw body includes a large-diameter smooth section extending from the head and a small-diameter threaded section extending from the large-diameter smooth section; and the first race member is disposed around the large-diameter smooth section.

6. The thrust screw of claim 5, wherein the head of the screw body has at the second surface an engaging portion for engaging with a screw-tightening tool.

7. The thrust screw of claim 6, wherein the engaging portion of the head of the screw body is a hexagonal recess extending through the head to the large-diameter smooth section of the shank of the screw body.
